(19) United States
(12) Patent Application Publication
(10) Pub. No.: US 2010/0094480 A1
(43) Pub. Date: Apr. 15, 2010

(54) APPARATUS AND A METHOD FOR A POWER TRANSMISSION SYSTEM

(76) Inventors: Lennart Ängquist, Enkoping (SE); Jan R. Svensson, Vasteras (SE); Masimo Bongiorno, Goteborg (SE)

Correspondence Address: VENABLE LLP, P.O. BOX 34385, WASHINGTON, DC, 20043-9998, US

(21) Appl. No.: 12/443,512

(22) PCT Filed: Sep. 29, 2006
(86) PCT No.: PCT/SE06/01106

§ 371 Date: Dec. 18, 2009

(51) Int. Cl. H02J 3/24

(52) U.S. Cl. 700/298

(57) ABSTRACT

An apparatus for reducing subsynchronous resonance phenomena in a power transmission system. A determining arrangement determines components of the voltage from stator windings of a generator with one or more discrete frequencies. A calculating arrangement calculates, on a basis of the result of the determining, a voltage to be added to the voltage from the stator windings for reducing phenomena in the power system and an arrangement adapted to add the voltage calculated to the voltage from the stator windings.

### TECHNICAL FIELD AND BACKGROUND OF THE INVENTION

The present invention is occupied with oscillations in a power transmission system comprising a power station with a generator of electric power with a rotor thereof included in a mechanical system and with the stator windings thereof connected to an electric system to be fed with electric power from the generator and susceptible to having electric resonance phenomena occurring therein.

Thus, the electric system has properties enabling electric resonance phenomena to occur therein, which means that the electric system includes a capacitance as well as a reactance, and one type of such electric system comprises a power transmission line with reactive power compensation in which an electric series resonance will be created by the line reactance and a series capacitor bank. Other types of electric systems susceptible to having electric resonance phenomena occurring therein are also covered.

Said power station may be any type of power station used for generating electric power, but a thermal power station will here be mentioned and briefly discussed, since the problems to be solved by the present invention are particularly accentuated in such stations, in which the generator and the different turbine stages are connected in a string by a set of shafts. In a first approximation the generator and the turbine stages may be considered to be rigid bodies having a substantial moment of inertia while the shafts are to some extent elastic with given spring constants characterizing the angular turning per unit torque. This combination of rigid bodies and torsion shafts exhibits mechanic resonances at certain frequencies, so-called “mode frequencies”. These so-called mechanic resonance frequencies of the mechanical system so formed may be accurately calculated and determined when designing the turbine-generator shaft system. A certain “mode shape” is associated with each resonance frequency and it shows the relative swing amplitude of the different masses at the specific mode frequency. Only such mechanic resonance frequencies in which the rotor of the generator participates are of interest here. These mechanic resonance frequencies normally appear below the nominal network frequency f_{N}, i.e. the frequency in said electric system, which may be for instance 50 Hz or 60 Hz, which is defined as the “subsynchronous frequency range”. Accordingly, such mechanic resonance frequencies fₘ may typically be for example 13 Hz, 25 Hz, 38 Hz and so on.

This means that the voltage from the stator windings of the generator will have components with one or more discrete frequencies in said subsynchronous frequency range being each the generator voltage frequency corresponding to the rotational speed of the rotor minus the respective mechanic resonance frequency of the mechanical system, accordingly f_{N} minus fₘ. This may under certain circumstances constitute a severe problem when said electric system connected to the generator is susceptible to having electric resonance phenomena occurring therein. By way of example, such an electric system comprising a power transmission line will now be briefly discussed. Long lines in electric transmission systems exhibit a substantial inductance, which reduces the permitted power transfer on the line due to angle and voltage stability requirements. The insertion of a fixed series capacitor bank providing negative reactance in series with the positive reactance caused by the line inductance reinductance reduces the effective reactance of the line, so that the maximum power transfer capability of the line increases. However, at the same time an electric series resonance will be created by the line reactance and the series capacitor bank. When only a portion of the line reactance is compensated the resonance frequency for the electric resonance appears below the network frequency f_{N}, i.e. in said “subsynchronous frequency range”, as said voltage component of the voltage from the stator windings of the generator.

When the following conditions are fulfilled a condition called Subsynchronous Resonance (SSR) may be established: The mechanical system has a torsional resonance at a frequency fₘ, the mode shape is such that the generator participates in the torsional oscillation at the frequency fₘ, the electric transmission system exhibits an electric resonance at frequency f_{N} minus fₘ, and the mechanic damping of the swing mode with frequency fₘ is low. The latter is especially the case when the generator loading is low, so that when the turbine connected thereto is idling.

Such an SSR condition can have negative damping, so that the amplitude of the torsional oscillation increases so that parts of the mechanical system, such as shafts, may be damaged. Thus, an SSR condition may lead to a catastrophic failure in a power system.

### PRIOR ART

U.S. Pat. No. 5,801,459 describes a method and a control equipment for a series capacitor connected in an electric power line with the aim to damp subsynchronous resonances occurring. However, this control method is dependent on the presence of a positive mechanical damping in the system. The main obstacle is that it is very difficult to determine a definite value of mechanical damping at the system design stage. Therefore the risk of SSR must be evaluated based on assumed mechanic damping values obtained from earlier experience.

### SUMMARY OF THE INVENTION

The object of the present invention is to provide reliable and efficient means enabling reductions of subsynchronous resonance phenomena in power transmission systems of the type defined above.

This object is according to the invention obtained by providing an apparatus comprising means for determining components of the voltage from said stator windings with one or more discrete frequencies being each the generator voltage frequency corresponding to the rotational speed of the rotor minus a mechanic resonance frequency of said mechanical system, means adapted to calculate, on the basis of the result of said determination, a voltage to be added to said voltage from the stator windings for reducing subsynchronous resonance phenomena in the power system and an arrangement adapted to add said voltage calculated to said voltage from the stator windings for reducing subsynchronous resonance phenomena in the power transmission system.

Thus, the invention is based on the understanding that the coupling between the mechanical oscillation and the electrical oscillation is one decisive condition for the SSR to exist. As explained above, when torsional oscillations have been established the generated voltage will be phase modulated relative to the rest of the power transmission system. The active power flow is tightly related to the phase difference between the generator voltage and the power system voltage. The resulting active power flow causes modulation of the electrodynamic torque in the generator. This means that a closed-loop is formed by the mechanically and the electrically oscillating systems. By the totally new approach to add a said voltage to the voltage from the stator windings, which counteracts the deviation of the generator voltage due to mechanical torsional oscillations said coupling may be reduced, and it may even be eliminated, so that subsynchronous resonances possibly occurring in said electric system will not be coupled and transferred to said mechanical system and damaging parts thereof. This method also enables mitigation of several SSR mode frequencies simultaneously.

It is pointed out that “voltage from the stator windings” is in this context to be interpreted to also include the voltage obtained after a possible transformation by a step-up transformer of the voltage generated in the stator windings. In such a case a voltage is added to the voltage obtained after said transformation for reducing said SSR phenomena.

According to an embodiment of the invention said calculating means is adapted to calculate a voltage to be added to the voltage from the stator windings for substantially cancelling out said voltage components with discrete frequencies in the voltage fed to said electric system and the arrangement is adapted to add said voltage to said voltage from the stator windings for substantially obtaining said cancelling out. This means that the coupling between the generator and said electric system and by that said decisive condition for the existence of SSR is eliminated. This is achieved since the voltage in said electric system beyond the point of said voltage addition becomes nonmodulated, so that no modulation of the active power is caused by torsional oscillation.

According to another embodiment of the invention said determining means comprises a member adapted to measure the current from said stator windings and means for filtering out components of the current so measured with said discrete frequencies, the calculating means is adapted to calculate, based upon information from said filtering means about said current components, the voltage to be added for cancelling out said current components and send information thereabout to said arrangement, and the arrangement is adapted to add the voltage thus calculated to said voltage from the stator windings for substantially cancelling out said current components. It has turned out that this way of determining said current components with said discrete frequencies and adding a voltage so that these current components disappear constitutes a very robust method for eliminating subsynchronous voltage components in the voltage to said electric system and by that the coupling between mechanical oscillations and electrical oscillations. This way of eliminating the deviation of the generator voltage due to torsional oscillations is very robust with respect to varying conditions in said electric system, such as varying degree of compensation in a transmission line with reactive power compensation.

According to another embodiment of the invention said determining means comprises a member adapted to substantially continuously establish values of the rotational speed of said rotor and a member adapted to calculate, based upon the development of rotational speed values thus established, components of the voltage from said stator windings with said discrete frequencies, said calculating means is adapted to calculate, based upon the result of the calculation of said voltage components, the voltage to be added to the voltage from said stator windings for cancelling out said voltage components with said discrete frequencies in the voltage fed to the electric system, and said arrangement is adapted to add the voltage thus calculated to the voltage from the stator windings for substantially cancelling out said voltage components. Such measurement of the rotational speed of the generator rotor makes it possible to calculate the appearance of the voltage in said stator winding, so that said coupling between the generator and the electric system may also in this way be eliminated or reduced by adding a corresponding voltage to the voltage from the stator windings.

According to another embodiment of the invention said determining means comprises a member adapted to measure the voltage in said stator windings and means for filtering out voltage components with said discrete frequencies from the voltage thus measured, said calculating means is adapted to calculate, based upon information from said filtering means about said voltage components, the voltage to be added to the voltage from said stator windings for cancelling out said voltage components with discrete frequencies in the voltage fed to the electric system, and said arrangement is adapted to add the voltage thus calculated to the voltage from the stator windings for substantially cancelling out said voltage components.

Accordingly, this apparatus achieve the object of the invention in a similar way as the apparatus according to the previous embodiment except for the fact that the voltage in the stator windings and by that the voltage components with said discrete frequencies are directly measured.

According to another embodiment of the invention said determining means comprises a member adapted to measure the voltage fed to said electric system at a point after said voltage has been added to the voltage from the stator windings and means for filtering out voltage components with said discrete frequencies from the voltage thus measured, said calculating means is adapted to calculate, based upon information from said filtering means about said voltage components, the voltage to be added for cancelling out said voltage components with discrete frequencies and send information thereabout to said arrangement, and the arrangement is adapted to add the voltage thus calculated to the voltage from the stator windings for substantially cancelling out said voltage components. This means that the addition of said voltage will be based upon appearance of said voltage components which by this addition will be reduced or eliminated so that an advantageous closed loop is formed.

According to another embodiment of the invention the apparatus further comprises means adapted to detect torsional oscillations in said mechanical system, said calculating means is adapted to calculate, based upon the result of said determination of said components with discrete frequencies as well as the result of said detection of torsional oscillations, a voltage to be added to said voltage from the stator windings for obtaining an active damping of said torsional oscillations, and said arrangement is adapted to add a voltage to said voltage from the stator windings creating a damping torque upon rotating parts of said mechanical system. This embodiment enables an active damping of torsional oscillations by adding a said voltage, which may prolong the lifetime of parts of said mechanical system.

According to another embodiment of the invention said arrangement comprises a VSC- (Voltage Source Converter) converter and a control unit adapted to control converter valves of the VSC-converter based upon the result of said calculation of said voltage to be added to the voltage from the stator windings. The use of a VSC-converter enables an efficient addition of a voltage having exactly the appearance required for obtaining the change of the voltage from the stator windings aimed at by appropriately controlling the converter valves, i.e. semiconductor devices of turn-off type, such as IGBTs, therein, of the VSC-converter.

According to other embodiments of the invention said arrangement comprises: a) a booster transformer connected to said stator windings and a said VSC-converter at ground potential arranged to feed said booster transformer according to the control of said control unit, or b) an H-bridge VSC-converter connected to each phase of a transmission line from said stator windings for adding said voltage by control of said control unit for the VSC-converter, or c) a 3-phase VSC-converter connected in series with a step-up transformer and connected to said stator windings at a ground connection of the transformer controlled by said control unit.

The invention also comprises a method for reducing subsynchronous resonance (SSR) phenomena in a power transmission system according to the appended method claims. The advantages of the different features of this method and the embodiments thereof appear clearly from the discussion above of the different embodiments of the apparatus according to the invention.

The invention also relates to a computer program as well as a computer readable medium according to the corresponding appended claims. The steps of the method according to the invention are well suited to be controlled by a processor provided with such a computer program.

The invention also comprises a use of an apparatus according to the invention for reducing subsynchronous resonance (SSR) phenomena in a power transmission system including a power transmission line provided with means for reactive power compensation as well as such a use in a power transmission system comprising a thermal power station having a generator connected to one or more turbine stages, which are particularly advantageous uses of an apparatus according to the invention.

Other advantages as well as advantageous features of the invention will appear from the following description.

### BRIEF DESCRIPTION OF THE DRAWINGS

With reference to the appended drawings, below follows a specific description of embodiments of the invention cited as examples.

In the drawings:

FIG. 1 is a schematic view of a power transmission system, in which a mechanical system is connected to an electric system, to which an apparatus and a method according to the present invention may be applied,

FIG. 2 is a very schematic view illustrating an apparatus according to a first embodiment of the invention applied to a power transmission system having a said electric system susceptible to having electric resonance phenomena occurring therein,

FIG. 3 is a view corresponding to FIG. 2 of an apparatus according to a second embodiment of the invention,

FIG. 4 is a view corresponding to FIG. 2 of an apparatus according to a third embodiment of the invention,

FIG. 5 is a view corresponding to FIG. 2 of an apparatus according to a fourth embodiment of the invention,

FIG. 6 is a view corresponding to FIG. 2 of an apparatus according to a fifth embodiment of the invention, and

FIG. 7-9 are views showing different ways of adding a voltage to the voltage from the stator windings in apparatuses according to the invention.

### DETAILED DESCRIPTION OF EMBODIMENTS OF THE INVENTION

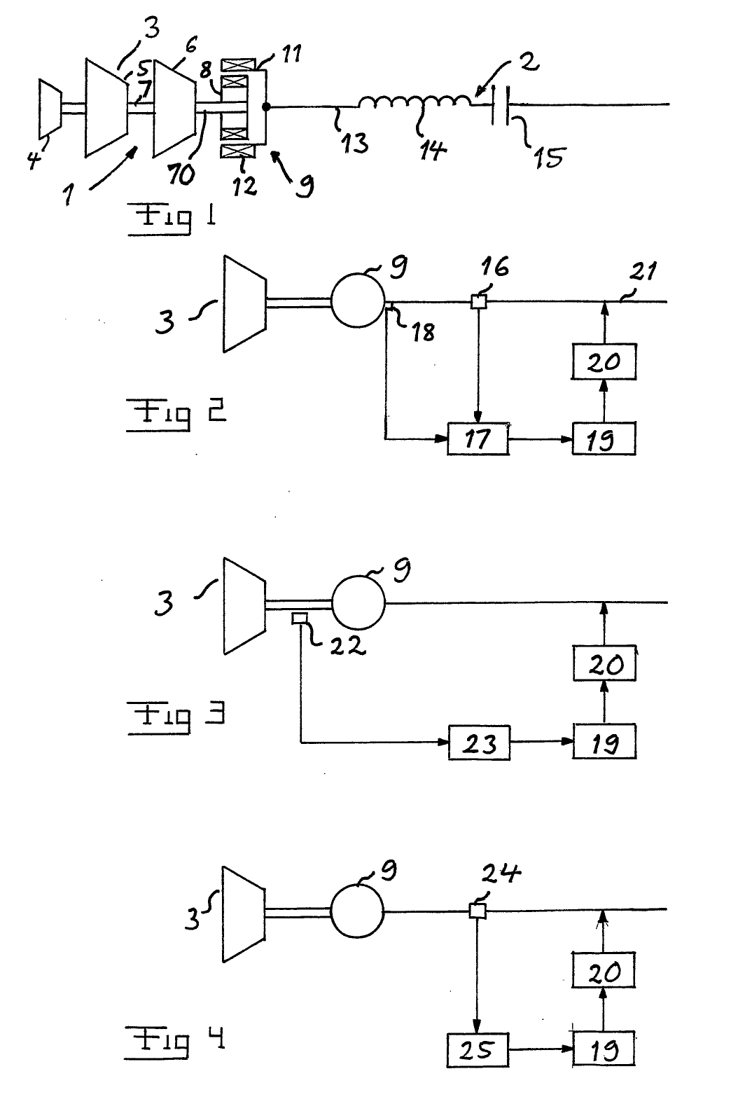

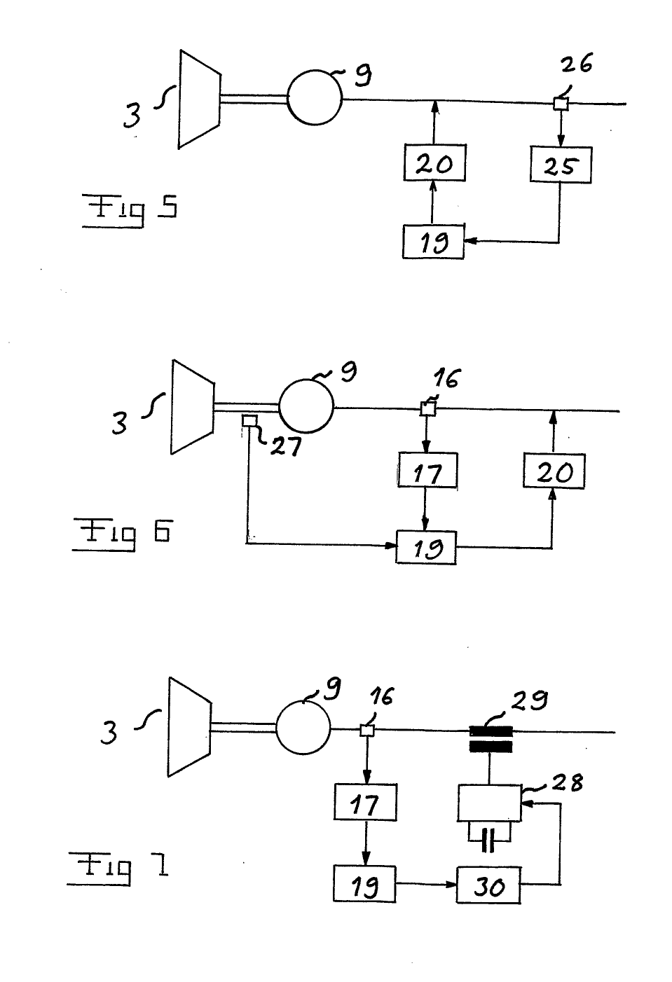

FIG. 1 illustrates a mechanical system 1 connected to an electric system 2. The mechanical system comprises a turbine 3 having a number of turbine stages 4-6, such as a high pressure, low pressure and an intermediate pressure stage, interconnected by shafts 7 and connected to a rotor 8 of a generator 9 through a rotor shaft 10.

The electrical system comprises a stator 11 with stator windings 12 of the generator and a power transmission line 13 connected to the stator windings 12. The power transmission line has a reactance indicated at 14. It is indicated at 15 how a series capacitor bank is connected to the line 13 for reactive power compensation.

As already explained subsynchronous voltage components will result in the voltage from the stator winding as a consequence of torsional oscillations in the mechanical system at determined frequencies, which may be determined already when the mechanical system is manufactured. These components will only be created when the generator, accordingly the rotor, participates in the oscillation mode in question. Furthermore, subsynchronous resonances may occur in the electric system 2 as a consequence of the reactance 14 and the capacitance 15 thereof. Subsynchronous resonance conditions may have a negative damping so that the amplitude of the torsional oscillation in the mechanical system increases so that the shaft system is damaged. The present invention remarkably mitigates these problems by advising measures enabling elimination of the coupling between the mechanical system and the electric system.

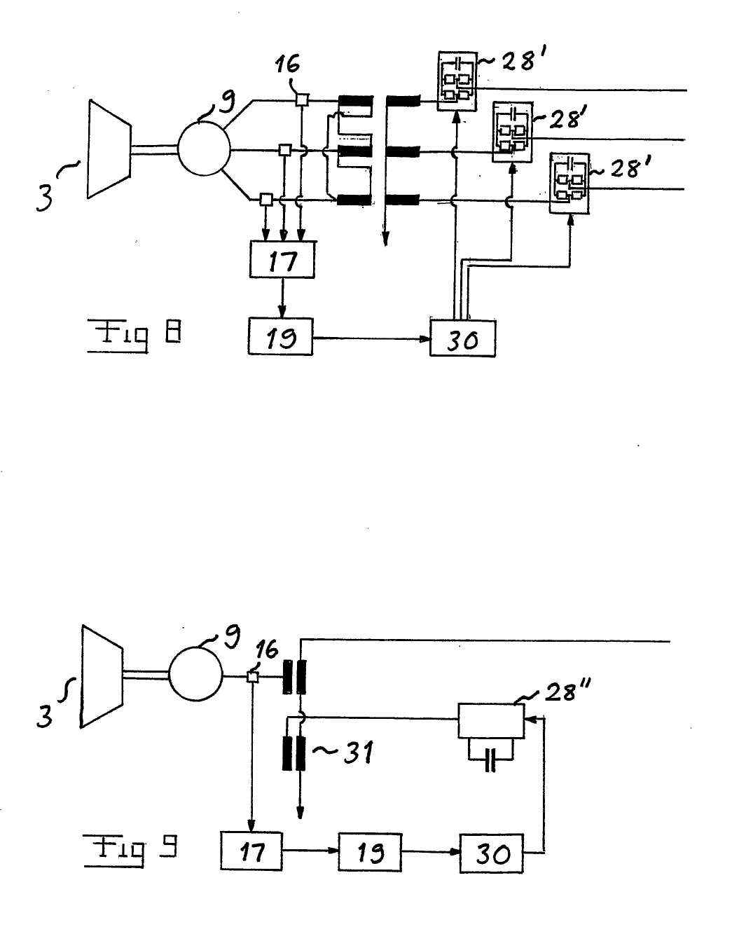

FIG. 2 shows an apparatus according to a first embodiment of the invention, which comprises a member 16 adapted to measure the current from the stator windings. A step-up transformer not shown in FIG. 2-9 is normally arranged between the generator 9 and the transmission line 13 for raising the level of the voltage created in the stator windings. The measurement of the current by the member 16 and the measurements of current and/or voltage in the embodiments described below takes place on the line side of said step-up transformer. If we assume that the mechanical system has mechanical resonance frequencies at 10 Hz, 20 Hz and 30 Hz and the frequency of the voltage in the stator windings is 50 Hz the current measured will contain components of the following frequencies in the subsynchronous range: 40 Hz (50 minus 10), 30 Hz (50 minus 20) and 20 Hz (50 minus 30). The apparatus also comprises filtering means 17 adapted to filtering out components of the current measured with said discrete frequencies. The apparatus also comprises means 18 in the form of a phase-locked loop (PLL) adapted to measure the frequency of the voltage generated in said stator windings by the rotation of the rotor 8 and send information thereabout to said filtering means, so that this may appropriately determine the discrete frequencies at stake. The apparatus also comprises calculating means 19 adapted to calculate, based upon information from said filtering means about said current components, a voltage to be added to the voltage from the stator windings for cancelling out said current components. The calculating means sends the result of this calculation to an arrangement 20 adapted to add said voltage calculated to said voltage from the stator windings, which in the case of the presence of a said step-up transformer is the voltage after transformation by this transformer, for substantially obtaining cancelling out of said current components and by that also of corresponding voltage components of the voltage downstream 21 said voltage addition. Possible designs of this arrangement 20 will be explained further below with reference to FIG. 7-9, which are all based on the use of a voltage source converter for obtaining suitable voltages to be added.

The width of the frequency bands of the filtering means 17 are preferably chosen to be comparatively narrow, which reduces the required rating of the converter used in the arrangement 20, so that it may be less than 5% of the power of the generator 9, but an optimum width of such a frequency band should be sought, since a wider frequency band would increase the speed of the apparatus. The method for reducing subsynchronous resonance phenomena, which may be carried out through the apparatus shown in FIG. 2, will be very robust thanks to the current measurement and the regulation of the discrete frequency components thereof towards zero with a possibility to simultaneously substantially eliminate such components of different frequencies.

FIG. 3 shows an apparatus according to a second embodiment of the invention, which comprises a member 22 adapted to substantially continuously establish values of the rotational speed of the rotor. A member 23 is adapted to calculate, based upon the development of the rotational speed values established, components of the voltage from the stator windings with said discrete frequencies. The calculating means 19 and the arrangement 20 are designed to act in a way corresponding to the description above of the embodiment shown in FIG. 2.

FIG. 4 illustrates an apparatus according to a third embodiment of the invention, which comprises a member 24 adapted to measure the voltage in the stator windings and means 25 for filtering out voltage components with said discrete frequencies from the voltage thus measured. The calculating means 19 and the arrangement 20 are designed to act in correspondence with above.

FIG. 5 illustrates an apparatus according to a fourth embodiment of the invention, which differs from the apparatus shown in FIG. 4 by the fact that the voltage measurement is here carried out by a member 26 at a point after said voltage has been added by the arrangement 20 to the voltage from the stator windings. This means that the addition of said voltage through the arrangement 20 will result in a disappearance of said components in the voltage measured by said member 26 corresponding to the current measurement in the embodiment shown in FIG. 2.

FIG. 6 illustrates an apparatus according to a fifth embodiment of the invention, which comprises means 27 adapted to detect torsional oscillations in the mechanical system and send information thereabout to a calculating unit 19, which also receives data from a measurement of the current from the stator winding and a filtering of the measurement result as in the embodiment according to FIG. 2. The calculating means 19 is here adapted to calculate, based upon the result of a determination of the current components with discrete frequencies as well as the result of the detection of torsional oscillations, a voltage to be added to the voltage from the stator windings for obtaining an active damping of said torsional oscillations, and the arrangement 20 is adapted to add a voltage to said voltage from the stator windings creating a damping torque upon rotating parts of the mechanical system. Thus, this apparatus may be used to obtain an active damping of such torsional oscillations, which may prolong the lifetime of components of the mechanical system.

FIG. 7 illustrates an embodiment of an arrangement which may be used in any of the embodiments of the apparatus according to the invention shown in FIG. 2-6, but it is here shown for the embodiment according to FIG. 2. This arrangement comprises a VSC-converter 28 at ground potential arranged to feed a booster transformer 29 connected to the stator windings. The arrangement 20 further comprises a control unit 30 adapted to control converter valves of the VSC-converter 28 for feeding said booster transformer 29 so that said discrete frequency voltage components of the voltage from the stator winding will be substantially cancelled out.

FIG. 8 illustrates another embodiment of the arrangement 20, which comprises an H-bridge VSC-converter 28′ connected to each phase of a transmission line from the stator windings for adding said voltage by said control of a control unit 30 for the converter.

Finally, FIG. 9 shows an arrangement 20 according a still further embodiment, which comprises a 3-phase VSC-converter 28″ connected in series with a step-up transformer 31 connected to said stator winding at a ground connection of the transformer.

The invention is of course not in any way restricted to the embodiments described above, but many possibilities to modifications thereof would be apparent to a person with ordinary skill in the art without departing from the basic idea of the invention as defined in the appended claims.

It is repeated that “voltage from the stator windings” and “current from the stator windings” may be a voltage and a current downstream a step-up transformer when such a transformer is connected to the stator windings.

1. An apparatus for reducing subsynchronous resonance phenomena in a power transmission system comprising a power station with a generator of electric power with a rotor thereof included in a mechanical system and with the stator windings thereof connected to an electric system to be fed with electric power from the generator and susceptible to have electric resonance phenomena occurring therein, the apparatus comprising:
a determining arrangement configured to determine components of the voltage from said stator windings with one or more discrete frequencies being each the generator voltage frequency corresponding to the rotational speed of said rotor minus a mechanic resonance frequency of said mechanical system,
a calculating arrangement configured to calculate, on a basis of the result of said determination, a voltage to be added to said voltage from the stator windings for reducing subsynchronous resonance phenomena in the power system, and
an arrangement adapted to add said voltage calculated to said voltage from the stator windings for reducing subsynchronous resonance phenomena in the power transmission system.

2. The apparatus according to claim 1, wherein the calculating arrangement is adapted to calculate a voltage to be added to the voltage from the stator windings for substantially cancelling out said voltage components with discrete frequencies in the voltage fed to said electric system, and wherein the arrangement is adapted to add said voltage to said voltage from the stator windings for substantially obtaining said cancelling out.

3. The apparatus according to claim 2, wherein said determining arrangement comprises a member adapted to measure the current from said stator windings and a filter configured to filter out components of the current so measured with said discrete frequencies, wherein the calculating arrangement is adapted to calculate, based upon information from said filter about said current components, the voltage to be added for cancelling out said current components and send information thereabout to said arrangement, and wherein the arrangement is adapted to add the voltage thus calculated to said voltage from the stator windings for substantially cancelling out said current components.

4. The apparatus according to claim 2, wherein said determining arrangement comprises a member adapted to substantially continuously establish values of the rotational speed of said rotor and a member adapted to calculate, based upon the development of rotational speed values thus established, components of the voltage from said stator windings with said discrete frequencies, wherein said calculating arrangement is adapted to calculate, based upon the result of the calculation of said voltage components, the voltage to be added to the voltage from said stator windings for cancelling out said voltage components with said discrete frequencies in the voltage fed to the electric system, and wherein said arrangement is adapted to add the voltage thus calculated to the voltage from the stator windings for substantially cancelling out said voltage components.

5. The apparatus according to claim 2, wherein said determining arrangement comprises a member adapted to measure the voltage in said stator windings and a filter configured to filter out voltage components with said discrete frequencies from the voltage thus measured, wherein said calculating arrangement is adapted to calculate, based upon information from said filter about said voltage components, the voltage to be added to the voltage from said stator windings for cancelling out said voltage components with discrete frequencies in the voltage fed to the electric system, and wherein said arrangement is adapted to add the voltage thus calculated to the voltage from the stator windings for substantially cancelling out said voltage components.

6. The apparatus according to claim 2, wherein said determining arrangement comprises a member adapted to measure the voltage fed to said electric system at a point after said voltage has been added to the voltage from the stator windings and a filter configured to filter out voltage components with said discrete frequencies from the voltage thus measured, wherein said calculating arrangement is adapted to calculate, based upon information from said filter about said voltage components, the voltage to be added for cancelling out said voltage components with discrete frequencies and send information thereabout to said arrangement, and wherein the arrangement is adapted to add the voltage thus calculated to the voltage from the stator windings for substantially cancelling out said voltage components.

7. The apparatus according to claim 1, further comprising:
a detector adapted to detect torsional oscillations in said mechanical system, wherein said calculating arrangement is adapted to calculate, based upon the result of said determination of said components with discrete frequencies as well as the result of said detection of torsional oscillations, a voltage to be added to said voltage from the stator windings for obtaining an active damping of said torsional oscillations, and wherein said arrangement is adapted to add a voltage to said voltage from the stator windings creating a damping torque upon rotating parts of said mechanical system.

8. The apparatus according to claim 1, wherein said arrangement comprises a voltage source converter and a control unit adapted to control converter valves of the voltage source converter based upon the result of said calculation of said voltage to be added to the voltage from the stator windings.

9. The apparatus according to claim 8, wherein said arrangement comprises a booster transformer connected to said stator windings and a said voltage source converter at ground potential arranged to feed said booster transformer according to the control of said control unit.

10. The apparatus according to claim 8, wherein said arrangement comprises an H-bridge voltage source converter connected to each phase of a transmission line from said stator windings for adding said voltage by control of a control unit for the voltage source converter.

11. The apparatus according to claim 8, wherein said arrangement comprises a 3-phase voltage source converter connected in series with a step-up transformer and connected to said stator windings at a ground connection of the transformer controlled by said control unit.

12. A method for reducing subsynchronous resonance phenomena in a power transmission system comprising a power station with a generator of electric power with a rotor thereof included in a mechanical system and with the stator windings thereof connected to an electric system to be fed with electric power from the generator and susceptible to having electric resonance phenomena occurring therein, the method comprising:
determining components of the voltage from said stator windings with one or more discrete frequencies being each the generator voltage frequency corresponding to the rotational speed of said rotor minus a mechanic resonance frequency of said mechanical system,
calculating, on a basis of the result of said determination, a voltage to be added to said voltage from the stator windings for reducing subsynchronous resonance phenomena in the power system, and
adding said voltage calculated to said voltage from the stator windings for reducing subsynchronous resonance phenomena in the power transmission system.

13. The method according to claim 12, wherein said calculating comprises calculation of a voltage to be added to the voltage from the stator windings for substantially cancelling out said voltage components with discrete frequencies in the voltage fed to said electric system, and wherein this voltage is added to said voltage from the stator windings for substantially obtaining said cancelling out.

14. The method according to claim 13, wherein said determining is carried out by measuring the current from said stator windings and filtering out components of the current so measured with said discrete frequencies, wherein said calculating comprises calculating the voltage to be added for cancelling out said current component on a basis of information obtained from said filtering out, and wherein the voltage thus calculated is added to the voltage from the stator windings for substantially cancelling out said current components.

15. The method according to claim 13, wherein said determining comprises a substantially continuous establishing of values of the rotational speed of said rotor and a calculation of components of the voltage from said stator windings with said discrete frequencies on a basis of the development of the rotational speed values established, wherein said calculating comprises calculating the voltage to be added to the voltage from said stator windings for cancelling out said voltage components with said discrete frequencies in the voltage fed to the electric system, and wherein the voltage thus calculated is added to the voltage from the stator windings for substantially cancelling out said voltage components.

16. The method according to claim 13, wherein said determining comprises measuring the voltage in said stator windings and filtering out voltage components with said discrete frequencies from the voltage thus measured, wherein said calculating comprises calculating the voltage to be added to the voltage from the stator windings for cancelling out said voltage components with discrete frequencies in the voltage fed to the electric system based upon information about said voltage components from said filtering out, and wherein the voltage thus calculated is added to the voltage from the stator windings for substantially cancelling out said voltage said voltage components.

17. The method according to claim 13, in wherein said determining comprises measuring the voltage fed to said electric system at a point after said voltage has been added to the voltage from the stator windings and filtering out voltage components with said discrete frequencies from the voltage thus measured, wherein said calculating comprises calculating the voltage to be added for cancelling out said voltage components with discrete frequencies on a basis of information from said filtering out, and wherein the voltage thus calculated is added to the voltage from the stator windings for substantially cancelling out said voltage components.

18. The method according to claim 12, further comprising:
measuring the frequency of the voltage generated in the stator windings through the rotation of the rotor by a phase-locked loop, wherein said determining comprises utilizing information from said voltage frequencies measurement for obtaining a value for said discrete frequencies used in said determination.

19. The method according to claim 12, further comprising:
detecting torsional oscillations in said mechanical system, wherein said calculating comprises calculating a voltage to be added to said voltage from the stator windings for obtaining an active damping of said torsional oscillations on a basis of the result of said determination of said components with discrete frequencies as well as the result of said detection of said torsional oscillations, and wherein a voltage is added to said voltage from the stator windings for creating a damping torque upon rotating parts of said mechanical system.

20. A computer program product, comprising:
a computer readable medium; and
computer program instructions recorded on the computer readable medium and executable by a processor for carrying out a method for reducing subsynchronous resonance phenomena in a power transmission system comprising a power station with a generator of electric power with a rotor thereof included in a mechanical system and with the stator windings thereof connected to an electric system to be fed with electric power from the generator and susceptible to having electric resonance phenomena occurring therein, the method comprising:
determining components of the voltage from said stator windings with one or more discrete frequencies being each the generator voltage frequency corresponding to the rotational speed of said rotor minus a mechanic resonance frequency of said mechanical system,
calculating, on a basis of the result of said determination, a voltage to be added to said voltage from the stator windings for reducing subsynchronous resonance phenomena in the power system, and
adding said voltage calculated to said voltage from the stator windings for reducing subsynchronous resonance phenomena in the power transmission system.

21. The computer program product according to claim 20, wherein the computer program instructions are provided at least partially through a network.

22. The computer program product according to claim 21, wherein the network is the internet.

23. The apparatus according to claim 1, wherein the power transmission system comprises a power transmission line comprises a reactive power compensator.

24. The apparatus according to claim 23, wherein power transmission system comprises a thermal power station having a generator connected to one or more turbine stages.
